(19) United States
(12) Patent Application Publication
(10) Pub. No.: US 2005/0224509 A1
(43) Pub. Date: Oct. 13, 2005

(54) No-spill beverage-storage system for vehicle console

(76) Inventors: Alan G. Dry, Grosse Pointe Woods, MI (US); Scott A. Moyer, Roseville, MI (US)

Correspondence Address: LEAR CORPORATION, BLISS MCGLYNN, P.C., 2075 WEST BIG BEAVER ROAD, SUITE 600, TROY, MI, 48084, US

(21) Appl. No.: 10/810,985

(22) Filed: Mar. 26, 2004

(51) Int. Cl. B60N 3/12; B60R 11/06; A47K 1/08

(52) U.S. Cl. 220/849

(57) ABSTRACT

A beverage-storage system for a vehicle console includes a bin having a floor and an open end defined substantially opposite the floor. A lid is adapted to open and close with respect to the bin and has an underside adapted to substantially close the open end of the bin. A tray is movably supportable at at least one predetermined height in spaced relation to the floor of the bin and adapted to support at least one beverage container. A seal is operatively connected to the underside of the lid and adapted to substantially seal off the top of the beverage container. The seal is also adapted to apply a force upon the beverage container against the tray upon closing the lid such that the beverage container is substantially prevented from moving relative to the storage system.

### BACKGROUND OF THE INVENTION

1. Field of the Invention

The present invention relates, generally, to a beverage holder for a vehicle and, more specifically, to a no-spill beverage-storage system for a vehicle console.

2. Description of the Related Art

Cup-holder assemblies are popular in modern vehicle designs and exist in countless variations having varying degrees of practicality. Such assemblies can often be found on the rear surface of the door of the glove box, extending from the dashboard, and in or near a console of the vehicle, just to name a few places.

Vehicle-interior designers have continually modified the designs of cup-holder assemblies over the years to improve the functionality of the assemblies. Even so, these assemblies are generally not designed to firmly hold a beverage container in place.

More specifically, cup-holder assemblies are known that support a beverage container and are designed such that the container can be easily manually placed in and removed from the assemblies. With this design, the container is often loosely held in the cup holder such that the container can move laterally or upwardly while the vehicle is in motion. This is particularly true when the vehicle is accelerating, via a change in either speed or direction, or riding on a non-uniform surface. Under either of these conditions, the container can easily slide along or rise from the floor of the assembly and, thus, make contact with an inner side or the top area of the assembly. At times, such contact can be sufficient to cause the container to bounce, tilt, or even tip such that the beverage can leak, splash, or spill onto an occupant or component of the passenger compartment of the vehicle. Accidents of this type can stain a component, such as carpet, of the passenger compartment or clothing of an occupant. Also, if the temperature of the beverage is relatively cold or hot, direct contact of the beverage onto skin of an occupant can cause significant discomfort to the occupant.

Cup-holder assemblies have also been designed to receive and hold a beverage container of only a particular size and shape. However, given that containers exist in various sizes and shapes, these assemblies are limited in their use. For example, a container greater in size than that for which an assembly is designed may not even fit into the assembly. In this case, the assembly is of no or very limited use. Also, a container smaller in size than that for which an assembly is designed may encounter the same problems as discussed above in connection with excess space within an assembly. In this case, the assembly is of limited use as well.

Furthermore, the cup-holder assemblies of the type known in the related art are generally not designed to seal the open end of the beverage container when the container is supported in the assemblies. As such, unless the container includes its own lid that seals the entire open end, tilting, tipping, or bouncing of the container can frequently result in loss of the beverage from within the container. Even lids that seal only partially the open end can cause such loss. Moreover, tipping or bouncing of the container can result in the container falling completely out of the assembly, which can lead to a lid being knocked off the container if the lid is not completely secured to the container. This can end in quite a mess for an occupant or the affected area of the passenger compartment.

Unfortunately, although the vehicle cup-holder assemblies of the related art are adapted to hold cans and bottles, an opened beverage can or bottle does not usually include a lid for sealing the open end of the can or bottle against leakage, spillage, or splash. Therefore, when held in the vehicle cup-holder assemblies of the related art, the can or bottle is at a much greater risk of leaking, spilling, or splashing its contents when the can or bottle tilts, tips, or bounces within the holder. This creates a constant spill hazard whenever the vehicle is at rest on an incline, for example, or moving, which, in turn, can create a comfort hazard and an aesthetically displeasing passenger compartment.

Also, the vehicle cup-holder assemblies of the related art are not designed to totally prevent beverage containers from moving with respect to the assemblies during motion of the vehicle. As a result, even under normal driving conditions, an unopened container supported within such assemblies and including a carbonated beverage can move sufficiently such that the beverage shakes to the point that upon opening the container, the beverage sprays into the passenger compartment.

Also, a constant spill hazard is especially created whenever the vehicle is being used “off road” where bouncy rides and sharp turns are quite common. In particular, even when a container includes a lid that seals the entire open end of the container, the roughness of “off road” traveling can be extreme enough such that the lid is inadvertently removed from the container. In any event, such spill hazards also can, in turn, create a comfort hazard and an aesthetically displeasing passenger compartment.

Accordingly, there remains a need in the related art for a system that stores a beverage container within the passenger compartment of a vehicle while preventing spillage or leakage of the beverage from the container, especially under extreme driving and vehicle conditions. There remains a need in the related art for such a system that can be used with more than one type of beverage container as well as beverage containers of various sizes. There also remains a need in the related art for such a system that can be used with an existing vehicle console and that can be easily and quickly converted to its inoperative position such that the console can be used for other purposes.

### SUMMARY OF THE INVENTION

The present invention overcomes the disadvantages in the related art in a no-spill beverage-storage system for a vehicle console. The storage system includes a bin having a floor and an open end defined substantially opposite the floor. A lid is adapted to open and close with respect to the bin and has an underside adapted to substantially close the open end of the bin. A tray is movably supportable at at least one predetermined height in spaced relation to the floor of the bin and adapted to support at least one beverage container. A seal is operatively connected to the underside of the lid and adapted to substantially seal off the top of the beverage container. The seal is also adapted to apply a force upon the beverage container against the tray upon closing the lid such that the beverage container is substantially prevented from moving relative to the storage system when the lid is in its closed position.

One advantage of the no-spill beverage-storage system for a vehicle console of the present invention is that it stores the beverage container while preventing spillage of beverage from within the container.

Another advantage of the no-spill beverage-storage system for a vehicle console of the present invention is that it prevents movement of the beverage container relative to the storage system.

Another advantage of the no-spill beverage-storage system for a vehicle console of the present invention is that a moisture-impervious surface seals off the top of the beverage container.

Another advantage of the no-spill beverage-storage system for a vehicle console of the present invention is that it is effective under extreme driving and vehicle conditions, even when the vehicle is inverted.

Another advantage of the no-spill beverage-storage system for a vehicle console of the present invention is that it can be used with an existing vehicle console.

Another advantage of the no-spill beverage-storage system for a vehicle console of the present invention is that it can be used with beverage containers of various sizes.

Another advantage of the no-spill beverage-storage system for a vehicle console of the present invention is that it can be used with more than one beverage container.

Another advantage of the no-spill beverage-storage system for a vehicle console of the present invention is that it can be easily and quickly converted to its inoperative position such that the storage system can be used for other purposes, such as for storing other objects.

Another advantage of the no-spill beverage-storage system for a vehicle console of the present invention is that the tray is removable and can be washed.

Another advantage of the no-spill beverage-storage system for a vehicle console of the present invention is that it requires few and relatively simple, robust, and inexpensive parts and is relatively inexpensive and easy to manufacture and install.

Other objects, features, and advantages of the present invention will be readily appreciated as the same becomes better understood while reading the subsequent description when taken in conjunction with the accompanying drawings.

### BRIEF DESCRIPTION OF THE DRAWINGS

Other advantages of the invention will be readily appreciated as the same becomes better understood by reference to the following detailed description when considered in connection with the accompanying drawings, wherein:

FIG. 1 is an environmental view of the no-spill beverage-storage system for a vehicle console of the present invention showing the console disposed in a passenger compartment of a motor vehicle;

FIG. 2 is a cross-sectional side view of the no-spill beverage-storage system for a vehicle console of the present invention showing the system in the operative position with the seal removably connected to the underside of the lid of the console and the tray supporting two beverage containers at a predetermined height above the floor of the bin of the console;

FIG. 3 is a cross-sectional side view of the no-spill beverage-storage system for a vehicle console of the present invention showing the system in the operative position with the tray supporting two beverage containers at a predetermined height above the floor of the bin different than the predetermined height illustrated in FIG. 2;

FIG. 4 is a cross-sectional side view of the no-spill beverage-storage system for a vehicle console of the present invention showing the system in the operative position with the tray supporting two beverage containers at a predetermined height above the floor of the bin by vertically flipping the tray illustrated in FIG. 3 by 180°;

FIG. 5 is a cross-sectional side view of the no-spill beverage-storage system for a vehicle console of the present invention showing the system in the operative position with the tray supporting two beverage containers at one of a plurality of possible predetermined heights above the floor of the bin;

FIG. 6 is a cross-sectional side view of the no-spill beverage-storage system for a vehicle console of the present invention showing the system in the operative position with the floor of the bin supporting one beverage container;

FIG. 7 is a cross-sectional side view of the no-spill beverage-storage system for a vehicle console of the present invention showing the system in the operative position and the seal adhesively connected to the underside of the lid of the console; and

FIG. 8 is a cross-sectional side view of the no-spill beverage-storage system for a vehicle console of the present invention showing the system with the beverages removed and the seal matingly receiving the tray such that the tray is retained and stored within the bin.

### DETAILED DESCRIPTION OF THE INVENTION

A no-spill beverage-storage system for a console of a motor vehicle according to the present invention is generally indicated at 10 throughout the figures, where like numerals are used to designate like structure. Although the storage system 10 is described below and shown in the figures used in connection with the center console of a motor vehicle in general, it will be appreciated by those having ordinary skill in the art that the storage system 10 can be used in connection with any suitable console of the vehicle. It will be also appreciated that the storage system 10 can also be used with any suitable type of beverage container having any suitable size and shape, made of any suitable material, and whether it includes a lid. It will be further appreciated that the storage system 10 also finds special applicability when the vehicle is used “off road,” where extremely bumpy riding and tight turning are common.

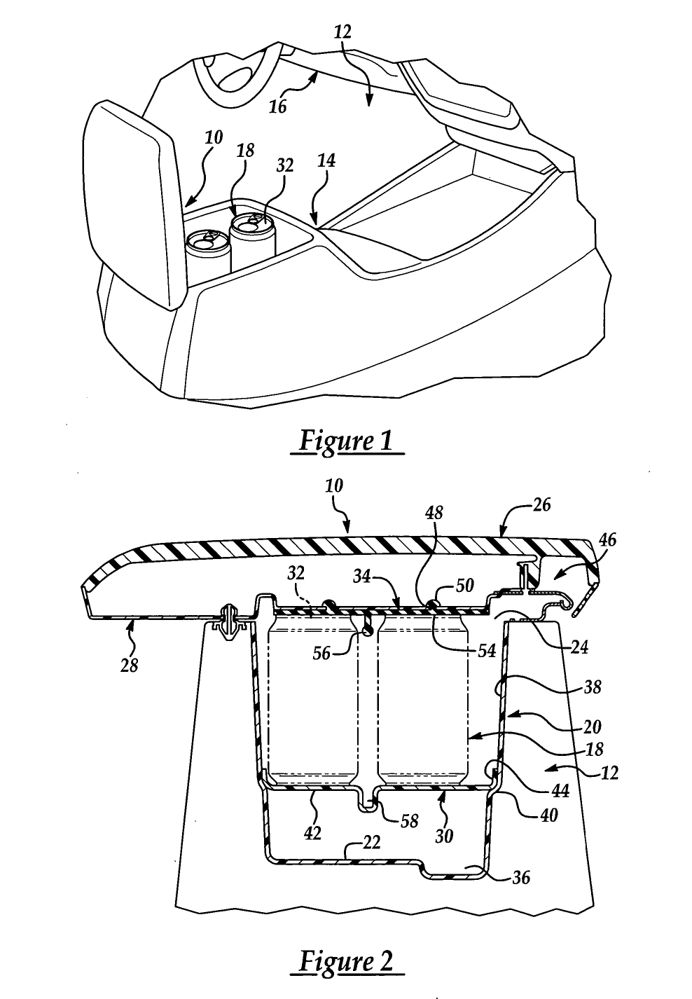

Referring now to FIG. 1, the interior, or, more specifically, the passenger compartment, of a motor vehicle is shown generally indicated at 12 and includes a center console, generally indicated at 14. The console 14 is disposed between a pair of front seats (not shown) and extends longitudinally from the dashboard, generally indicated at 16, to the second row of seating (not shown). The console 14 is designed to include various structural features for receiving various articles, such as a beverage container, generally indicated at 18 in FIG. 1.

Those having ordinary skill in the art will appreciate that a center console is a standard feature of a passenger compartment and the storage system 10 can be used with center consoles having varying designs and structural relationships with respect to a passenger compartment. It will also be appreciated that the storage system 10 does not include a console per se, but can consist of an entire console. However, the storage system 10 shown in FIG. 1 is a part of the console 14 and can act as an armrest for each of the front-seat occupants when the storage system 10 is in the operative mode.

Referring now to FIGS. 2 through 7, the storage system 10 generally includes a bin, generally indicated at 20, having a floor 22 and an open end 24 defined substantially opposite the floor 22. A lid, generally indicated at 26, is adapted to open and close with respect to the bin 20 and has an underside, generally indicated at 28, adapted to substantially close the open end 24 of the bin 20. A tray, generally indicated at 30, is movably supportable at at least one predetermined height in spaced relation to the floor 22 of the bin 20 and adapted to support at least one beverage container 18 having an at least partially openable top 32. A seal, generally indicated at 34, is operatively connected to the underside 28 of the lid 26 and adapted to substantially seal off the top 32 of the beverage container 18. The seal 34 is also adapted to apply a force upon the beverage container 18 against the tray 30 upon closing the lid 26 such that the beverage container 18 is substantially prevented from moving relative to the storage system 10.

In a preferred embodiment of the storage system 10 illustrated in FIGS. 2 through 8, the bin 20 has a substantially narrow trapezoidal cross-section and defines an interior volume of space. The longer end of the bin 20 is disposed closer to the top of the passenger compartment 12 and defines the open end 24. The shorter end of the bin 20 defines the floor 22, which is substantially parallel with the open end 24 and flat, except for a substantially shallow recess 36 defined by the floor 22 toward one side of the bin 20. The recess 36 is adapted to receive substantially narrow or small articles, such as coins. However, those having ordinary skill in the art will appreciate that the recess 36 is optional and the entire floor 22 can be substantially flat or any other suitable shape.

The interior of the bin 20 shown in the figures is designed to support two beverage containers 18 side-by-side such that some space can remain about each container 18. Of course, the amount of space depends upon the size of each container 18 with respect to the interior of the bin 20. Those having ordinary skill in the art will appreciate that the interior of the bin 20 can have any suitable shape and size to support any suitable number of beverage containers 18. Those having ordinary skill in the art will also appreciate that the bin 20 can have any suitable shape and size and structural relationship with respect to the passenger compartment 12.

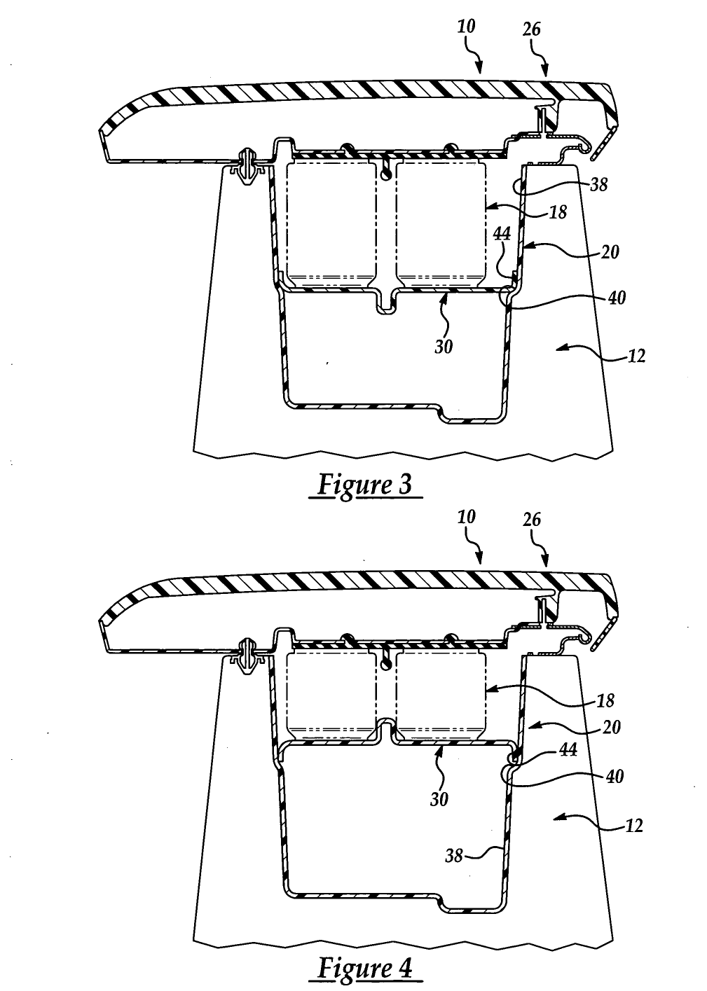

As shown in FIGS. 2 through 8, the bin 20 also defines at least one wall 38 defining at least one corresponding ledge 40 adapted to support the tray 30. Preferably, the bin 20 defines at least one pair of opposed walls 38 defining at least one corresponding pair of opposed ledges 40 adapted to support the tray 30. The ledges 40 and, thus, the tray 30 are disposed a predetermined distance below the opening 24 to correspond to the height of a particular type of beverage container 18. For example, the containers 18 shown in FIG. 2 may be cans of the type commonly used to contain twelve ounces of beverage. Alternatively and as shown in FIG. 3, the ledges 40 and, thus, the tray 30 can be disposed a predetermined distance below the opening 24 less than that shown in FIG. 2 to correspond to the height of a type of beverage container 18 that is shorter than that shown in FIG. 2. For example, the containers 18 shown in FIG. 3 may be cans of the type commonly used to contain ten ounces of a beverage. Regardless, the ledges 40 can be designed to conform to a beverage container 18 of any suitable height.

Of course, the resulting distance between the tray 30 and the floor 22 depends upon the depth of the interior of the bin 20. The length of the tray 30 depends upon the width of the interior of the bin 20 at the proper distance below the opening 24 of the bin 20. The thickness of the tray 30 and the material from which it is constructed is a matter of design preference, but must be sufficient to support the beverage container(s) 18.

The ledges 40 are disposed such that they support the tray 30 substantially parallel with the floor 22. As shown in FIGS. 2 through 8, each ledge 40 defines an angle greater than 90° with respect to the corresponding wall 38. However, it will be appreciated by those having ordinary skill in the art that the ledge(s) 40 can define any suitable angle with respect to the corresponding wall(s) 38. Furthermore, it is preferred that each ledge 40 is integrally molded to the corresponding wall 38.

As shown in FIGS. 2-5, 7, and 8, the tray 30 includes at least one substantially planar surface 42 adapted to support the beverage container(s) 18. Preferably and as shown in these figures, the tray 30 includes a pair of substantially planar surfaces 42 adapted to support a pair of corresponding beverage containers 18. Also, the periphery of one face of the tray 30 defines a pair of opposed lips 44 adapted to cooperatively engage the corresponding ledges 40 and walls 38 to support the tray 30. As shown in FIGS. 2 through 5 and 7, the lips 44 operatively extend substantially along the corresponding walls 38 for a predetermined length. For a reason that will be discussed in greater detail below, the length of each lip 44 is preferably the same. As shown in FIGS. 2-5, 7, and 8, the portion of the tray 30 joining each lip 44 and the corresponding planar surface 42 is arcuate, and each lip 44 forms an angle greater than 90° with respect to the corresponding planar surface 42.

The tray 30 is also reversibly supportable in the bin 20 via the ends of the lips 44. As a result, the tray 30 is supportable at either of two predetermined heights in spaced relation relative to the floor 22 of the bin 20. The length of the lips 44 determines one such height, namely, that when the tray 30 is reversibly supported. In FIG. 4, the tray 30 is shown reversibly supported on the ends of the lips 44. As such, the tray 30 is disposed a predetermined distance below the opening 24 less than that shown in FIG. 3 to correspond to the height of a type of beverage container 18 that is shorter than that shown in FIG. 3. For example, the containers 18 shown in FIG. 4 may be mugs of the type commonly used to contain eight ounces of a beverage.

In addition, those having ordinary skill in the art will appreciate that, although not shown, the periphery of the other face of the tray 30 can also define a pair of opposed lips 44 such that two sets of lips 44 disposed in back-to-back relationship with respect to each other are formed. In this case, to support the tray 30, the pair of lips 44 disposed below the planar surfaces 42 are adapted to cooperatively engage both the corresponding ledges 40 and walls 38, and the other pair of lips 44 disposed above the planar surfaces 42 are adapted to cooperatively engage only the corresponding walls 38. Also, the pair of lips 44 disposed below the planar surfaces 42 are shorter or longer than the pair of lips 44 disposed above the planar surfaces 42. In this way, the tray 30 is reversibly supportable at either of two predetermined heights in spaced relation relative to the floor 22 of the bin 20.

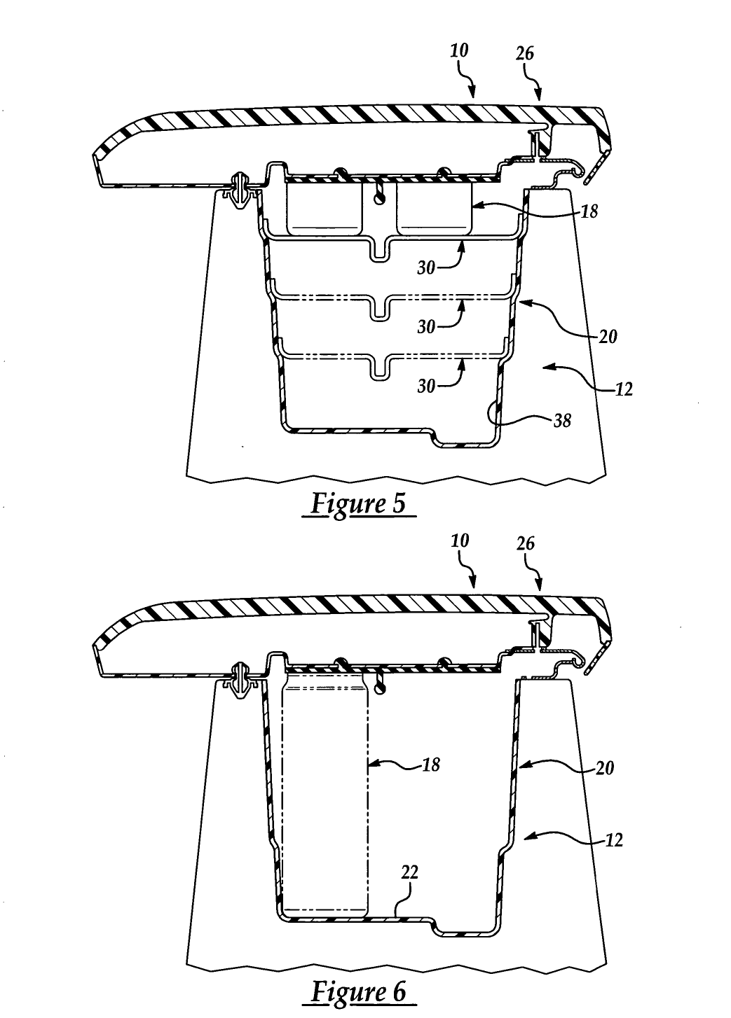

Moreover, a plurality of pairs of opposed ledges 40 can be disposed in spaced relationship with respect to one another along the corresponding walls 38 such that the tray 40 can be supported at any of a plurality of predetermined heights in spaced relation relative to the floor 36 of the bin 20. For instance, although the tray 40 shown in FIG. 5 is supported at the topmost available height, the tray 30 can actually be supported at two lower predetermined heights. Accordingly, the tray 30 is disposed a predetermined distance below the opening 24 less than that shown in FIG. 4 to correspond to the height of a type of beverage container 18 shorter than that shown in FIG. 4. For example, the containers 18 shown in FIG. 5 may be mugs of the type commonly used to contain six ounces of a beverage. In FIG. 5, adjacent pairs of opposed ledges 40 are substantially equidistantly spaced. However, those having ordinary skill in the art will appreciate that any suitable number of pairs of opposed ledges 40 can be disposed in spaced relationship with respect to one another and adjacent pairs can be spaced from each other by any suitable distance. In one preferred embodiment, the storage system 10 includes a suitably sized tray 30 for each pair of opposed ledges 40.

As shown in FIG. 6, the tray 30 can be removed such that the floor 22 of the bin 20, as opposed to the tray 30, is adapted to support the beverage container(s) 18. In this case, the seal 34 is adapted to apply a force upon each beverage container 18 against the floor 22, rather than the tray 30, upon closing the lid 26 such that each beverage container 18 is substantially prevented from moving relative to the storage system 10. In FIG. 6, only one container 18 is shown, and the tray 30 is totally removed from the bin 20. As a result, a predetermined distance below the opening 24 is created greater than that shown in FIG. 2 to correspond to the height of a type of beverage container 18 taller than that shown in FIG. 2. For example, the container 18 shown in FIG. 6 may be a can of the type commonly used to contain twenty ounces of a beverage.

As shown in FIGS. 2 through 8, the lid 26 is hingedly connected to the bin via a hinge mechanism, generally indicated at 46, such that the lid is adapted to open and securely close with respect to the opening 24 of the bin. The hinge mechanism 46 is adapted to permit rotation of the lid 26 a sufficient amount for placement and removal of the beverage container(s) 28 into/from the bin 20. However, those having ordinary skill in the art will appreciate that the lid 26 does not need to be hingedly connected to the bin 20 and any suitable hinge mechanism 46 known in the art can be used with the lid 26. The lid 26 covers the substantially entire open end 24 of the bin 20, and the end of the lid 26 opposite the hinge mechanism 46 extends beyond the corresponding wall of the bin 20 to act as a handle. However, those having ordinary skill in the art will appreciate that the lid 26 can have any suitable size and shape with respect to the bin 20 and can have any structure that acts as a mechanism for opening and securely closing the lid 26.

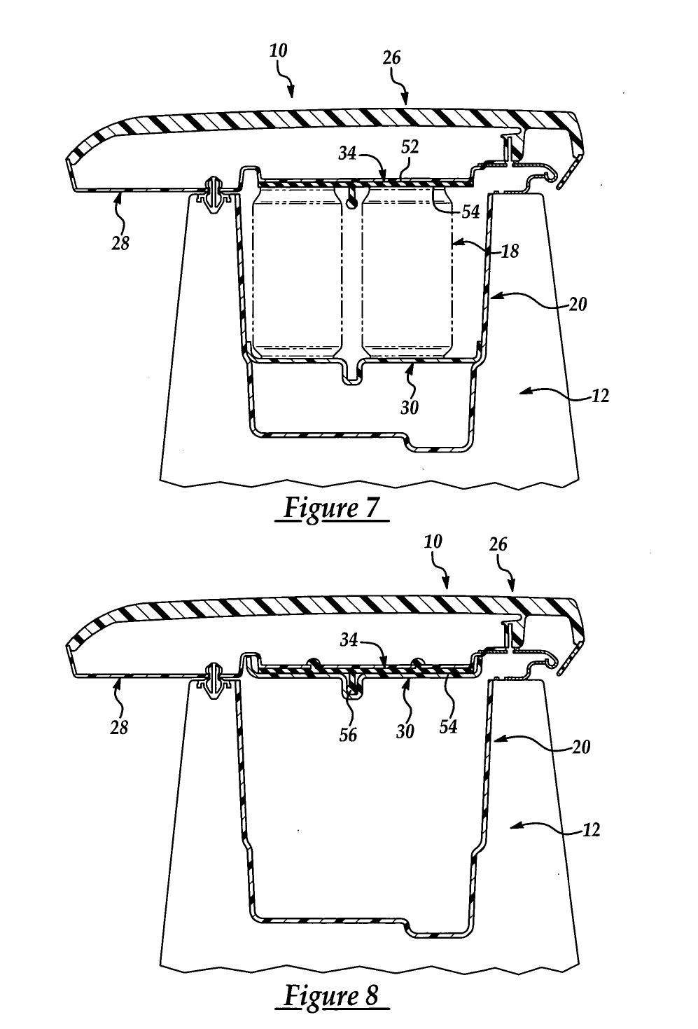

The seal 34 is removably mounted to the underside 28 of the lid 26. For example and as shown in FIGS. 2 through 6 and 8, the underside 28 of the lid 26 includes at least one opening 48, and the seal 34 includes at least one fastener 50 adapted to be securely received in the corresponding opening 48 to removably connect the seal 34 to the underside 28 of the lid 26. Preferably, the fastener 50 is a molded nub or hook. In these figures, a pair of such openings 48 and corresponding fasteners 50 are shown. Alternatively and as shown in FIG. 7, the underside 28 of the lid 26 can include an adhesive 52 disposed between the seal 34 and the lid 26 such that the seal 34 is adhesively connected to the underside 28 of the lid 26. However, it will be appreciated by those having ordinary skill in the art that the seal 34 can be removably mounted to the underside 28 of the lid 26 by any suitable structure.

The seal includes a pad 34 having a substantially resilient, moisture-impervious surface 54 adapted to substantially seal off the top 32 of each beverage container 18 and apply the force upon each beverage container 18 against the tray 30 upon closing the lid 26. Preferably, the pad 34 includes open-cell-foam, and the surface 54 is made from neoprene.

The seal 34 also is adapted to retain and store the tray 30 when the tray 30 is not supporting a beverage container 18. To this end and as shown in FIG. 8, the seal 34 can include at least one fastener 56 operatively extending in the direction of the bin 20, and the tray 30 can define at least one recess 58 adapted to matingly receive the corresponding fastener 56 to retain and store the tray 30 when the tray 30 is not supporting the beverage container 18. In FIG. 8, a single fastener, such as a nub 56, and corresponding recess 58 are shown. The nub 56 is disposed in a substantially central location of the surface 54 of the seal 34, and the recess 58 is disposed in a substantially central location of the tray 30. In particular, the recess 58 is substantially shallow and has a substantially rectangular cross-section. The recess 58 also defines the pair planar surfaces 42 of the tray 30, which are substantially equal in length. As can be seen, the beverage containers 18 cannot be disposed side-by-side any closer than the nub 56 permits, and the tray 30 cannot be supported within the bin 20 any lower than the depth of the recess 58 permits. However, it will be appreciated by those having ordinary skill in the art that the seal 34 can retain and store the tray 30 by any suitable structure.

In operation, when an occupant of the vehicle desires to use the storage system 10 to store a beverage container 18, the occupant determines the proper distance below the pad 34 at which the container 18 must be supported. Based upon such determination, the occupant opens the lid 26 a sufficient amount such that a beverage container 18 can be placed on the tray 30 or the floor 22 of the bin 20 if a tray 30 is already properly supported within the bin 20 or the floor 22 is at the proper distance below the opening 24, respectively. Otherwise, the tray 30 must be flipped to support it on the same pair of ledges 40, support the tray 30 on a different pair of ledges 40 if they are available, remove the tray 30 from a pair of ledges 40 such that the beverage container 18 may be placed on the floor 22, or remove the stored tray 30 from the pad 34 or from outside the storage system 10 and properly support the tray 30 within the bin 20. Then, the lid 26 may be securely closed with respect to the opening 24 of the bin 20 such that the surface 54 of the pad 34 seals off the top 32 of the beverage container 18. The pad 34 applies a force upon the beverage container 18 against the tray 30 or floor 22 upon closing the lid 26 such that the beverage container 18 is substantially prevented from moving relative to the storage system 10. The lid 26 can then be opened at any suitable time to remove from the bin 20 the beverage container 18, which has not lost any beverage contained therein.

As can easily be seen, the storage system 10 stores a beverage container 18 while preventing spillage of beverage from within the container 18 and also prevents movement of the container 18 relative to the storage system 10. A moisture-impervious surface 34 seals off the top of the beverage container 18. The storage system 10 also is effective under extreme driving and vehicle conditions, even when the vehicle is inverted. The storage system 10 also can be used with an existing vehicle console 14, beverage containers 18 of various sizes, and more than one beverage container 18 and easily and quickly converted to its inoperative position such that the storage system 10 can be used for other purposes, such as for storing other objects. Further, the tray 30 is removable and can be washed. The storage system 10 also requires few and relatively simple, robust, and inexpensive parts and is relatively inexpensive and easy to manufacture and install.

The present invention has been described in an illustrative manner. It is to be understood that the terminology that has been used is intended to be in the nature of words of description rather than of limitation. Many modifications and variations of the present invention are possible in light of the above teachings. Therefore, within the scope of the appended claims, the present invention may be practiced other than as specifically described.

1. A beverage-storage system for a vehicle console, said storage system comprising:
a bin having a floor and an open end defined substantially opposite said floor;
a lid adapted to open and close with respect to said bin and having an underside adapted to substantially close said open end of said bin;
a tray movably supportable at at least one predetermined height in spaced relation relative to said floor of said bin and adapted to support at least one beverage container; and
a seal operatively connected to the underside of said lid and adapted to substantially seal off the top of the beverage container and apply a force upon the beverage container against said tray upon closing said lid such that the beverage container is substantially prevented from moving relative to the storage system.

2. A beverage-storage system as set forth in claim 1, wherein said bin defines at least one wall defining at least one corresponding ledge adapted to support said tray.

3. A beverage-storage system as set forth in claim 2, wherein said bin defines at least one pair of opposed walls defining at least one corresponding pair of opposed ledges adapted to support said tray.

4. A beverage-storage system as set forth in claim 2, wherein said at least one ledge includes a plurality of ledges disposed in spaced relationship with respect to one another along the corresponding wall such that said tray can be supported at any of a plurality of predetermined heights in spaced relation relative to said floor of said bin.

5. A beverage-storage system as set forth in claim 2, wherein the periphery of one face of said tray defines at least one lip adapted to cooperatively engage said corresponding ledge and wall to support said tray.

6. A beverage-storage system as set forth in claim 5, wherein said lip operatively extends substantially along said corresponding wall for a predetermined length, said tray being reversibly supportable in the longitudinal direction of said lip at either of two predetermined heights in spaced relation relative to said floor of said bin.

7. A beverage-storage system as set forth in claim 5, wherein said tray includes at least one substantially planar surface adapted to support a beverage container.

8. A beverage-storage system as set forth in claim 2, wherein said ledge is integrally molded to said corresponding wall.

9. A beverage-storage system as set forth in claim 1, wherein said seal is removably mounted to said underside of said lid.

10. A beverage-storage system as set forth in claim 9, wherein said underside of said lid includes at least one opening and said seal includes at least one fastener adapted to be securely received in said corresponding opening to removably connect said seal to said underside of said lid.

11. A beverage-storage system as set forth in claim 1, wherein said seal includes a pad having a substantially resilient, moisture-impervious surface adapted to substantially seal off the top of a beverage container and apply the force upon the beverage container against said tray upon closing said lid.

12. A beverage-storage system as set forth in claim 11, wherein said surface is made from neoprene.

13. A beverage-storage system as set forth in claim 1, wherein said seal includes an open-cell-foam pad having a moisture-impervious surface adapted to substantially seal off the top of a beverage container and apply the force upon the beverage container against said tray upon closing said lid.

14. A beverage-storage system as set forth in claim 1, wherein said storage system further includes an adhesive disposed between said seal and said lid such that said seal is adhesively connected to said underside of said lid.

15. A beverage-storage system as set forth in claim 1, wherein said seal is adapted to retain and store said tray when said tray is not supporting a beverage container.

16. A beverage-storage system as set forth in claim 15, wherein said seal includes at least one fastener operatively extending in the direction of said bin and said tray defines at least one recess adapted to matingly receive said corresponding fastener to retain and store said tray when said tray is not supporting the beverage container.

17. A beverage-storage system as set forth in claim 1, wherein said lid is hingedly connected to said bin such that said lid is adapted to open and close with respect to said bin.

18. A beverage-storage system for a vehicle console, said storage system comprising:
a bin having a floor adapted to support at least one beverage container and an open end defined substantially opposite said floor;
a lid adapted to open and close with respect to said bin and having an underside adapted to substantially close said open end of said bin; and
a seal operatively connected to said underside of said lid and adapted to substantially seal off the top of the beverage container and apply a force upon the beverage container against said floor of said bin upon closing said lid such that the beverage container is substantially prevented from moving relative to the console.
